(19) United States
(12) Patent Application Publication
(10) Pub. No.: US 2026/0349704 A1
(43) Pub. Date: Nov. 5, 2026

(54) PORTABLE OFFLINE ARTIFICIAL INTELLIGENCE VOICE ASSISTANT DEVICE WITH MODULAR DOMAIN KNOWLEDGE PACKS

(71) Applicant: Georgios Feretzakis, Melissia (GR)

(72) Inventor: Georgios Feretzakis, Melissia (GR)

(21) Appl. No.: 19/658,489

(22) Filed: Apr. 25, 2026

Related U.S. Application Data
(60) Provisional application No. 63/799,451, filed on May 3, 2025.

(51) Int. Cl. G06F 8/65; G06F 1/26; G06F 1/30; G06F 16/334; G06F 21/86; G10L 13/08; G10L 15/26; H04L 9/08; H04L 9/32

(52) U.S. Cl. CPC G06F 8/65; G06F 1/263; G06F 1/305; G06F 16/3347; G06F 21/86; G10L 13/08; G10L 15/26; H04L 9/0852; H04L 9/3247

(57) ABSTRACT

A portable voice-assistant device includes a rugged enclosure housing an AI processor that executes speech-to-text, language-model inference, and text-to-speech synthesis entirely on-device without external network connectivity. The device features a removable storage interface for mounting Domain Pack archives at run-time to augment AI responses with domain-specific knowledge, including optional adapter weights for language-model specialization. Hot-swappable battery packs with super-capacitor hold-up power and an MPPT solar charge controller enable sustained field operation. A security microcontroller validates Domain Packs using post-quantum digital signatures and triggers cryptographic key zeroization upon tamper detection. The firmware provides mutually-exclusive Open and Secure configuration modes. An optional multimodal sensor pod enables on-device vision processing with embedding fusion. A method of offline voice-query processing using retrieval-augmented generation from Domain Packs is also disclosed.

### CROSS-REFERENCE TO RELATED APPLICATIONS

This application claims the benefit of U.S. Provisional Application No. 63/799,451, filed May 3, 2025, the entire disclosure of which is incorporated herein by reference.

### FIELD OF THE INVENTION

The present invention relates generally to standalone voice-assistant devices and, more particularly, to portable devices that execute speech-to-text, large-language-model reasoning, and text-to-speech entirely on-device without external network services, and that are extensible via software modules referred to herein as “Domain Packs.” The invention further relates to methods of processing voice queries offline using retrieval-augmented language-model inference, and to computer-readable storage media configured as modular Domain Packs for such devices.

### BACKGROUND OF THE INVENTION

Cloud-based voice assistants, while powerful, present significant limitations in environments where network connectivity is unavailable, unreliable, or presents unacceptable security risks. Such environments include military operations, remote field research, privacy-conscious enterprises, humanitarian aid operations, disaster-response scenarios, and educational institutions in remote or under-developed regions.

Existing offline voice-assistant devices are limited to command-and-control functionality and lack the capacity for complex language-model reasoning. No known handheld device integrates all of the following capabilities: (i) on-device large language model (LLM) inference, (ii) hot-swappable domain-specific knowledge packs, (iii) an ingress-protection-rated, tamper-resistant enclosure, (iv) hot-swappable power sources, (v) integrated maximum power point tracking (MPPT) solar charging, (vi) tamper-reactive secure-erase functionality, and (vii) optional multimodal sensor fusion.

During natural disasters when communications infrastructure fails, in refugee camps requiring secure coordination, in remote villages lacking internet connectivity, and in crisis zones where data security is paramount, traditional cloud-based AI assistants become unavailable precisely when they are most needed. Humanitarian workers, medical personnel, educators, and first responders require reliable offline AI assistance that can operate independently of network infrastructure while maintaining data security and providing domain-specific knowledge for critical decision-making.

Schools in low-resource regions require offline educational AI tools that function without reliable internet access, deliver curriculum-aligned content, and support teachers in resource-limited environments.

Current solutions fail to address these critical needs, leaving vulnerable populations without AI-assisted services during emergencies, perpetuating educational disparities in offline communities, and hampering humanitarian efforts where secure, reliable information tools could save lives and improve outcomes.

Accordingly, there is a need for a portable, rugged, offline AI voice assistant that combines on-device language model processing with modular, securable domain knowledge, hot-swappable power, and optional multimodal sensing capabilities.

### SUMMARY OF THE INVENTION

The present invention provides a portable voice-assistant device, associated methods of operation, and modular Domain Pack media that address the foregoing limitations.

In one aspect, the invention provides a portable voice-assistant device comprising a rugged enclosure housing an AI processor that executes speech-to-text, language-model inference, and text-to-speech synthesis entirely on-device. The device features a removable storage interface for mounting Domain Pack archives at run-time to augment AI responses with domain-specific knowledge without requiring reboot, and a hot-swappable power supply for sustained field operation.

In another aspect, the invention provides a method of processing voice queries on a portable device without external network connectivity, comprising detecting a wake-word, performing on-device speech recognition, optionally retrieving context from a mounted Domain Pack via vector similarity search, generating a response using a quantized language model, and synthesizing audio output, all without any data leaving the device.

In yet another aspect, the invention provides a non-transitory computer-readable storage medium configured as a removable Domain Pack, the storage medium storing a Domain Pack archive comprising a manifest with a hash tree, a vector index of pre-computed embeddings, a content store of text passages associated with the pre-computed embeddings, optional adapter weights for language-model specialization, and a post-quantum digital signature for integrity verification.

The device may further include full on-device AI processing via wake-word DSP, quantized ASR, quantized LLM inference, and neural TTS synthesis. Domain Packs may be post-quantum-signed archives mountable at run-time. Rugged power management may include dual hot-swappable battery packs with super-capacitor hold-up and MPPT solar charging. Two mutually-exclusive variants may be provided: an Open Edition with wireless radios and support for unsigned Domain Packs, and a Secure Edition with disabled radios and signed-only Domain Packs. Tamper security may be provided via a sensor mesh coupled to secure-erase logic. An optional multimodal sensor pod may add vision capabilities to the offline LLM.

### BRIEF DESCRIPTION OF THE DRAWINGS

FIG. 1 is an exterior view of the portable voice-assistant device with annotated features according to an embodiment of the present invention.

FIG. 2 is an internal block diagram showing the power management subsystem, AI system-on-chip, non-volatile storage, security microcontroller, Domain-Pack engine, and optional radios according to an embodiment of the present invention.

FIG. 3 is a flowchart illustrating the offline voice-query processing method according to an embodiment of the present invention.

FIG. 4 illustrates Domain-Pack deployment flows for the Open Edition and the Secure Edition according to embodiments of the present invention.

FIG. 5 is a device-variant comparison summary illustrating the differences between the Open/Educational Edition and the Secure Edition according to embodiments of the present invention.

### DETAILED DESCRIPTION OF THE PREFERRED EMBODIMENTS

The following detailed description is provided to enable any person skilled in the art to make and use the invention. It will be apparent to one of ordinary skill in the art that modifications and variations can be made to the described embodiments without departing from the spirit and scope of the invention. Thus, it is intended that the present invention covers such modifications and variations as come within the scope of the appended claims and their equivalents.

### Hardware Architecture

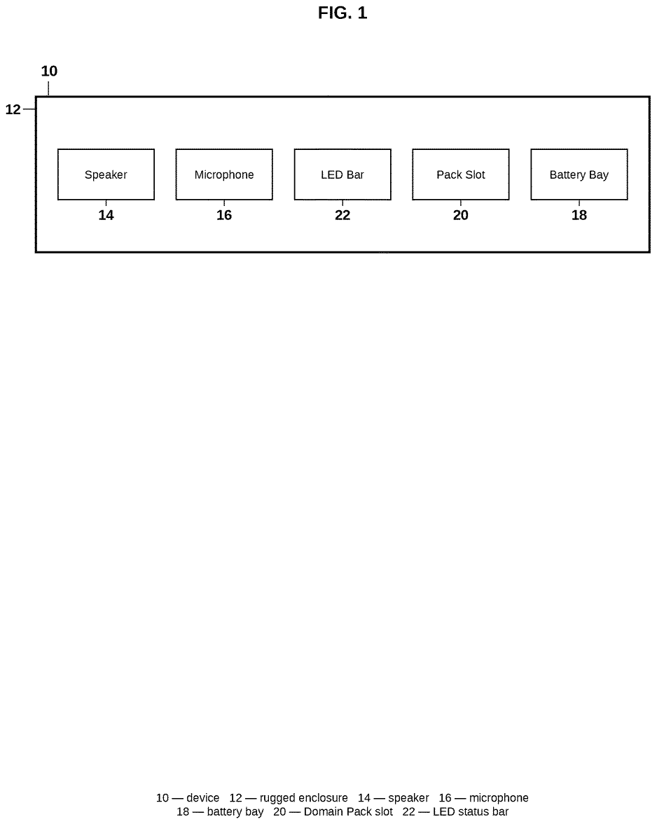

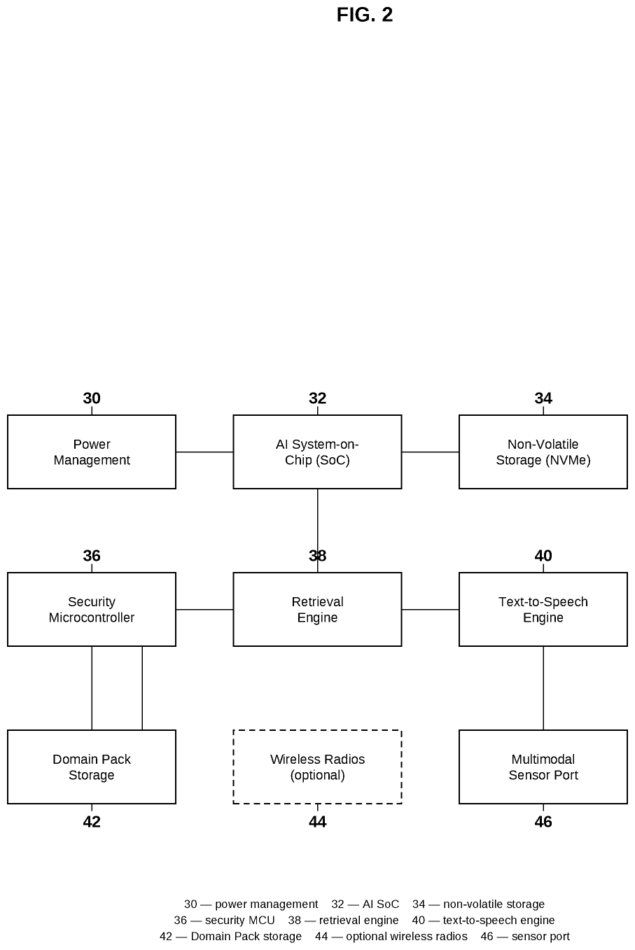

Referring now to FIGS. 1 and 2, a portable voice-assistant device 10 according to an embodiment of the present invention includes a rugged enclosure 12 having an ingress protection rating suitable for field deployment (e.g., IP67). The enclosure 12 houses the electronic subsystems described below.

A power management board 30 delivers regulated 5 V and 3.3 V power rails to the system components. The power board 30 also hosts a 96-layer NAND non-volatile memory express (NVMe) solid-state drive (SSD) 34 connected via a PCI Express (PCIe) Gen-3 x1 lane for local model and data storage.

An AI system-on-chip (SoC) 32 performs all speech recognition, language-model inference, and text-to-speech synthesis. In a preferred embodiment, the AI SoC 32 is an NVIDIA Jetson Orin Nano 8 GB module providing 40-67 tera operations per second (TOPS) at 7-15 watts. Alternatively, the AI SoC 32 may be a Qualcomm QCS8550 system-on-module providing up to 70 TOPS. More generally, the AI processing unit may be implemented using ARM-based, x86, RISC-V, or proprietary neural accelerators, including future devices offering comparable performance, thereby ensuring the inventive concepts are not limited to a single hardware class.

### Thermal Management

A thermal management subsystem maintains reliable processor operation during sustained inference workloads. In the illustrated embodiment, a vapor-chamber heat spreader coupled with a graphite thermal pad thermally connects the SoC 32 to the aluminum frame of the enclosure 12, maintaining junction temperature below 85 degrees Celsius in ambient temperatures up to 45 degrees Celsius. This passive cooling approach avoids moving parts and maintains the enclosure's ingress protection rating.

### Power Management and Hot-Swappable Battery

A battery bay 18 accommodates two 18 Wh lithium-ion battery packs that are individually hot-swappable. A 10 F super-capacitor provides approximately 200 milliseconds of hold-up power during battery swap operations, ensuring continuous device operation without interruption or data loss. A user may thus replace a depleted battery while the device continues to operate on the remaining battery and super-capacitor hold-up energy.

The power management board 30 integrates an MPPT charge controller accepting 18-24 V DC input (up to approximately 3 amperes) from a foldable solar blanket or panel, enabling recharge during operation. Typical operating autonomy is 8-10 hours in standby mode or 3-4 hours in continuous dialogue mode.

### Audio Input and Output Subsystems

The device 10 includes IP67-rated MEMS microphones for voice input capture and a high-fidelity speaker for audio output of synthesized speech responses. A multi-color LED status bar provides visual feedback indicating device states including at least an idle state, a listening state, a processing state, and a low battery condition.

### Always-On Wake-Word Detection

An always-on, low-power digital signal processor (DSP) continuously monitors audio input from the microphones for a predetermined wake-word. The DSP operates at substantially lower power consumption than the main AI SoC 32 during language-model inference, thereby conserving battery power during idle periods. Upon detecting the wake-word, the DSP triggers the full speech processing pipeline on the AI SoC 32.

### Domain Pack Interface and Mounting

A hot-swappable Domain Pack slot accepts removable storage media carrying Domain Pack archives. In the illustrated embodiment, the removable Domain Packs are CFexpress Type B cards carrying an NVMe namespace. However, any hot-swappable, non-volatile medium that provides comparable PCIe/NVMe, SD-UHS, USB-mass-storage, or successor signaling (e.g., M.2-2230 NVMe modules or industrial microSD cards) may be substituted without departing from the inventive concept. Domain Packs may be inserted and removed without requiring device reboot.

Upon insertion, the firmware validates the Domain Pack archive (as described below) and, upon successful validation, mounts the Domain Pack in a read-only mode, preventing modification of Domain Pack content during operation. The mounted Domain Pack is registered with the retrieval engine 38 so that subsequent voice queries may draw upon the domain-specific knowledge contained therein. In embodiments supporting multiple Domain Pack slots or multiple pack files stored on a single medium, the firmware may simultaneously mount a plurality of Domain Pack archives and select relevant passages from one or more of the plurality of mounted Domain Pack archives during a single query-response cycle.

### Security Subsystem

A security microcontroller (MCU) 36 manages cryptographic operations including Domain Pack signature verification and tamper detection. A reed-switch mesh disposed inside the enclosure 12 triggers zeroization of LLM weights and Domain-Pack cryptographic keys if the enclosure shell is pried open or otherwise breached without authorization.

### Optional Multimodal Sensor Module

An accessory port on the enclosure 12 exposes at least one of a MIPI CSI-2 interface and an SPI interface. An optional camera/LiDAR sensor pod module connects via this accessory port and streams sensor data frames to the AI SoC 32 for multimodal reasoning, including object identification and optical character recognition (OCR). The processor generates vision embeddings from the sensor data and fuses these vision embeddings with text embeddings derived from transcribed speech to generate enhanced responses. All sensor data processing occurs locally on the device without any data leaving the device.

### Domain-Pack File Format

Each Domain Pack is a “.vqp” archive formatted as a ZIP-64 container comprising: (1) a metadata.json manifest file containing name, version, and a hash tree data structure with cryptographic hashes for each component file within the archive; (2) an index.faiss vector index file containing pre-computed embeddings as float16 or int8 vectors organized as a Hierarchical Navigable Small World (HNSW) graph; (3) one or more content store files, also referred to as a passage store or chunk database, such as chunks.jsonl, passages.sqlite, or content.db, containing text passages, document chunks, and associated metadata referenced by entries of the vector index, wherein each embedding in the vector index corresponds to one or more text passages stored in the content store; (4) optional adapter weight files, such as lora. bin (LoRA adapter weights) or gguf (quantized model weights), for specializing the base language model for the domain of the pack without replacing the base model; and (5) a sig. bin file containing a post-quantum digital signature, generated by a post-quantum digital-signature algorithm such as ML-DSA (Module-Lattice-Based Digital Signature Algorithm, FIPS 204; including parameter sets ML-DSA-44, ML-DSA-65 and ML-DSA-87), CRYSTALS-Dilithium, SLH-DSA (Stateless Hash-Based Digital Signature Algorithm, FIPS 205), or another post-quantum digital-signature algorithm, computed over items (1) through (4). The maximum archive size is 32 GB.

The content store described in item (3) of the preceding paragraph is an inherent component of any retrieval-augmented generation (RAG) architecture in which a vector index is used to identify relevant text passages, since the vector index by itself stores only embeddings (numerical vectors) and corresponding identifiers, while the actual text passages or document chunks must reside in an associated data store accessible to the language model. Accordingly, references in this disclosure and in the appended claims to retrieving text passages from a Domain Pack archive include retrieving such text passages from a content store contained within or otherwise associated with the Domain Pack archive, regardless of whether such content store is implemented as a separate file (e.g., chunks.jsonl, passages. sqlite, or content.db), embedded within the same physical file as the vector index, or distributed across multiple files within the Domain Pack archive. The skilled artisan would have understood, from the disclosure of vector retrieval and top-k passage retrieval in the parent provisional application (Application No. 63/799,451), that a corresponding content store is an inherent prerequisite for retrieving text passages associated with embeddings of the vector index.

The firmware is configured to access content from a mounted Domain Pack archive by streaming data pages directly from NVMe storage 34 without fully extracting the archive into working memory. This streaming approach enables efficient use of device memory even with large Domain Pack archives.

When adapter weight files are present, the processor applies the adapter weights to modify parameters of the language model to specialize inference for the domain associated with the Domain Pack, without replacing the base language model. This enables domain-specific expertise while maintaining general-purpose capabilities.

### Domain Pack Deployment and Distribution

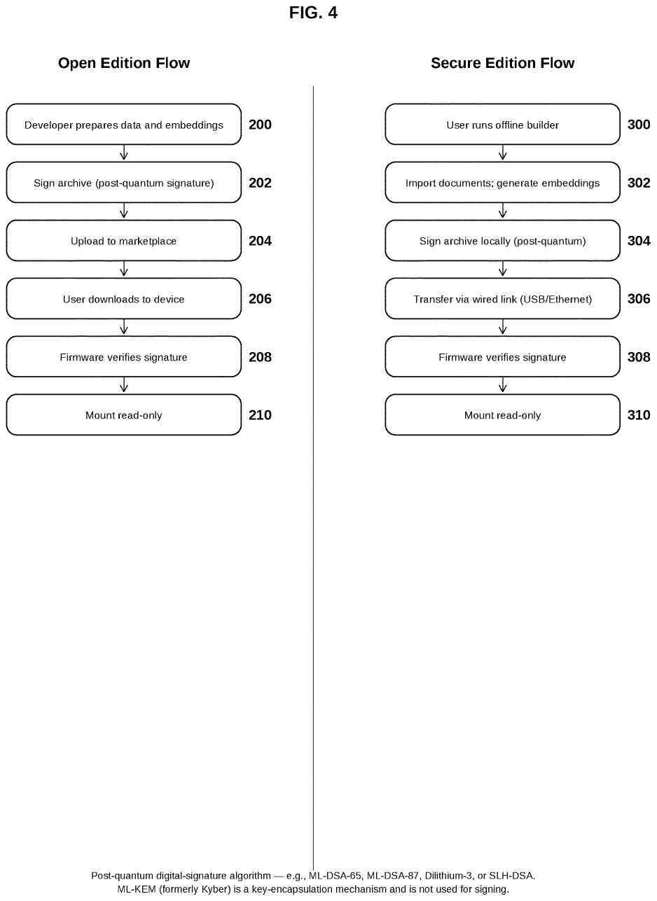

Referring to FIG. 4, each Domain Pack archive may be verified by the security MCU 36 using a post-quantum digital-signature verification algorithm such as ML-DSA-65 or ML-DSA-87 (FIPS 204), CRYSTALS-Dilithium (e.g., Dilithium-3), SLH-DSA (FIPS 205), or another post-quantum digital-signature algorithm. The firmware verifies the integrity of each component file within the archive against its corresponding cryptographic hash in the hash tree of the manifest file prior to activation. Upon successful verification, the Domain Pack is mounted read-only and registered with the retrieval engine 38. If any component hash fails verification, the firmware refuses activation of the Domain Pack. In some embodiments, a separate post-quantum key-encapsulation mechanism (KEM) such as ML-KEM (FIPS 203, also known as Kyber) may additionally be used to establish symmetric keys for confidentiality of Domain Pack content; ML-KEM is used for key establishment and is not used as a digital-signature algorithm.

For the Open Edition, Domain Packs may be downloaded or purchased through an online marketplace that distributes post-quantum-signed archives. The firmware may communicate with a remote server to browse, download, and install Domain Pack archives from the marketplace. For the Secure Edition, Domain Packs are obtained exclusively from an offline builder workstation and transferred to the device via a wired connection such as USB or Ethernet, as illustrated in FIG. 4. The offline builder workstation allows users to import documents, generate embeddings, package the archive, and sign it locally using post-quantum cryptographic keys.

### Voice Query Processing Flow

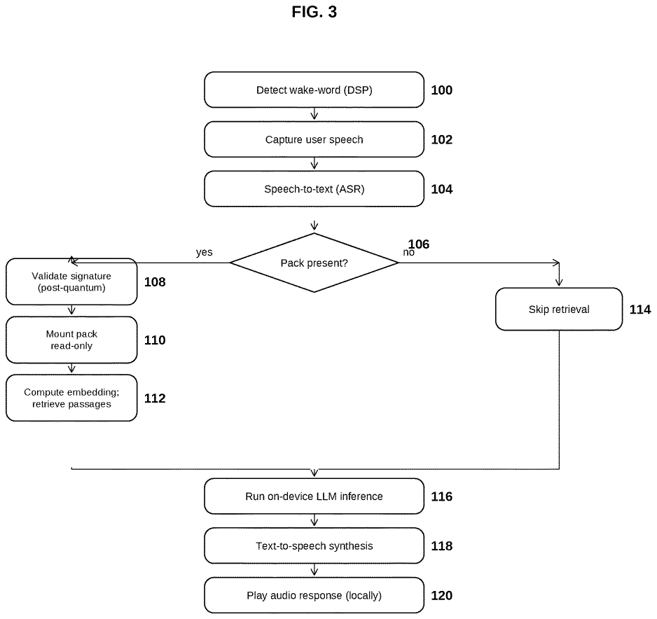

Referring to FIG. 3, the voice query processing method operates as follows. The always-on DSP monitors ambient audio for a predetermined wake-word. Upon wake-word detection, the system captures user speech until silence is detected. The captured audio is converted to text using an on-device speech recognition model (e.g., Whisper-INT8 ASR).

The system then determines whether a Domain Pack archive is currently mounted on the device. If a Domain Pack is mounted, the system computes a query embedding from the transcribed text, performs vector similarity search against the vector index of the mounted Domain Pack archive to identify top-k matching embeddings, and retrieves the corresponding text passages from the content store of the mounted Domain Pack archive. The retrieved passages are supplied as context to the language model.

The quantized language model (e.g., 0.5-1 billion parameters at 4-bit precision) processes the query along with any retrieved context to generate a response text. When the optional sensor pod is attached, vision embeddings derived from sensor data are fused with the text embeddings and retrieved passages as additional input to the language model. The response text is then synthesized to audio via an on-device text-to-speech engine (e.g., Piper TTS) and played through the speaker.

Throughout this entire processing flow, from wake-word detection through audio output, no data is transmitted to any external network. All processing steps are performed entirely on the portable device using local computational resources.

### Device Variants

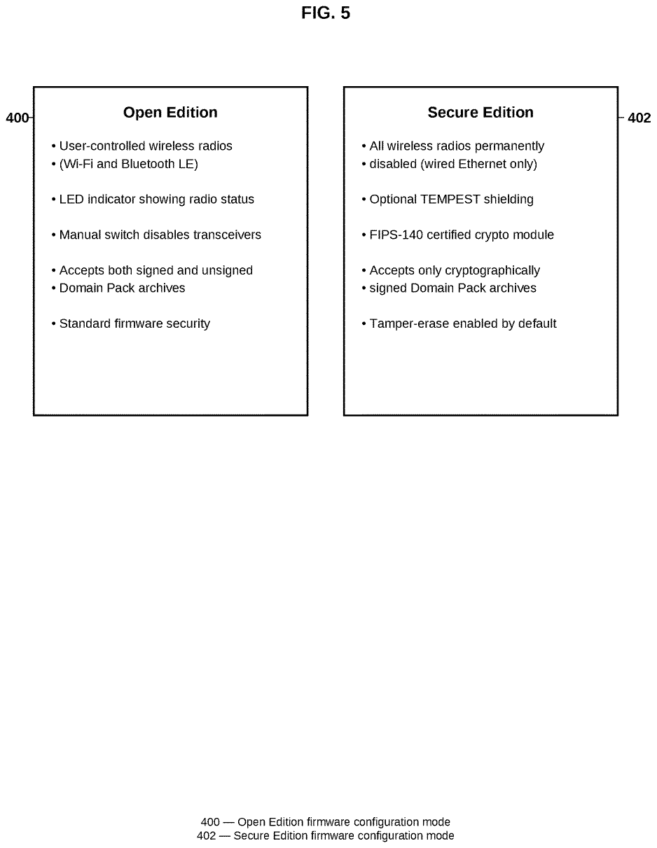

Referring to FIG. 5, the device firmware provides two mutually-exclusive configuration modes. The Open Edition (also designated the Educational Edition) enables user-controlled wireless radios (Wi-Fi and Bluetooth LE) with an LED indicator showing radio status, a manual switch that disables all wireless transceivers (the indicator illuminating only when transceivers are enabled), accepts both signed and unsigned Domain Packs, and provides standard firmware security. The Secure Edition permanently disables all wireless radios (permitting only wired Ethernet connectivity), provides optional TEMPEST electromagnetic shielding, includes a FIPS-140 certified cryptographic module, accepts only cryptographically signed Domain Packs, and enables tamper-erase by default.

### Humanitarian and Educational Applications

In certain embodiments, the device includes pre-loaded Domain Packs optimized for humanitarian applications including disaster-response protocols, medical triage procedures, educational content for offline learning, and multi-language translation capabilities for use in crisis zones.

While the foregoing description has described particular embodiments, it should be understood that the invention is not so limited and modifications may be made without departing from the spirit and scope of the invention as set forth in the following claims.

What is claimed is:

1. A portable voice-assistant device comprising: a rugged enclosure; an audio input subsystem; an audio output subsystem; a processor housed within the rugged enclosure and configured to execute on-device speech-to-text conversion, language-model inference, and text-to-speech synthesis; non-volatile memory coupled to the processor and storing speech recognition models, language model weights, and text-to-speech models; a hot-swappable power supply; a removable storage interface; and firmware stored in the non-volatile memory and executable by the processor, the firmware configured to: (i) process voice queries received via the audio input subsystem entirely offline without requiring external network connectivity, and (ii) mount a Domain Pack archive received via the removable storage interface to augment language-model responses without requiring device reboot.

2. The device of claim 1, wherein the firmware is configured to validate each Domain Pack archive using a post-quantum digital-signature algorithm and to reject the Domain Pack archive if validation fails.

3. The device of claim 1, further comprising a retrieval engine executed by the processor, the retrieval engine configured to compute a query embedding from transcribed speech, perform vector similarity search against a vector index contained within a mounted Domain Pack archive to identify one or more matching embeddings, and retrieve corresponding text passages from a content store contained within the mounted Domain Pack archive, the retrieved text passages being supplied as context to the language-model inference.

4. The device of claim 3, wherein the Domain Pack archive further comprises adapter weight files, and the processor is configured to apply the adapter weight files to modify parameters of the language model to specialize inference for a domain associated with the Domain Pack archive without replacing the base language model.

5. The device of claim 1, further comprising a secondary energy store coupled to the hot-swappable power supply, the secondary energy store configured to power the device during removal of a primary battery to enable hot-swap of the primary battery without interrupting device operation.

6. The device of claim 1, further comprising a charge-controller circuit including a maximum power point tracking (MPPT) controller, the charge-controller circuit configured to accept direct-current power from a portable solar panel and to recharge the hot-swappable power supply while the device remains operational.

7. The device of claim 1, further comprising at least one tamper-detect sensor coupled to tamper-response logic, the tamper-response logic configured to, upon detecting an unauthorized opening of the rugged enclosure, erase cryptographic keys stored in the device and disable all stored Domain Pack archives.

8. The device of claim 1, further comprising a removable multimodal sensor module connectable to the device via an accessory port, the removable multimodal sensor module including at least one of a camera and a depth sensor, the processor being configured to generate embeddings from data received from the removable multimodal sensor module and fuse the generated embeddings with text embeddings derived from transcribed speech to generate responses to user queries.

9. The device of claim 1, wherein the firmware is configured to provide two mutually-exclusive configuration modes comprising: an Open Edition mode that enables user-controlled wireless radios and permits installation of unsigned Domain Pack archives; and a Secure Edition mode that permanently disables wireless radios and authorizes only cryptographically signed Domain Pack archives.

10. The device of claim 1, wherein the firmware is configured to access content from a mounted Domain Pack archive by streaming data pages directly from non-volatile storage without fully extracting the archive into working memory.

11. The device of claim 1, wherein the firmware mounts each validated Domain Pack archive in a read-only mode preventing modification of Domain Pack content during operation, and wherein the Domain Pack archive comprises a manifest file containing a hash tree data structure with cryptographic hashes for each component file within the archive, and the firmware verifies the integrity of each component file against its corresponding hash in the hash tree prior to activation.

12. The device of claim 9, wherein in the Open Edition mode, the firmware is further configured to communicate with a remote server to download Domain Pack archives from an online marketplace, the online marketplace distributing only cryptographically-signed Domain Pack archives.

13. A method of processing voice queries on a portable device without external network connectivity, the method comprising: (a) detecting a wake-word from ambient audio using an always-on low-power digital signal processor; (b) capturing user speech subsequent to wake-word detection; (c) converting the captured user speech to text using an on-device speech recognition model; (d) determining whether a Domain Pack archive is mounted on the portable device; (e) when a Domain Pack archive is mounted, computing a query embedding from the text, performing vector similarity search against a vector index within the Domain Pack archive to identify one or more matching embeddings, and retrieving corresponding text passages from a content store within the Domain Pack archive; (f) generating a response by executing a quantized language model on the portable device using the text and any retrieved text passages as input; (g) synthesizing the response into audio using an on-device text-to-speech engine; and (h) outputting the synthesized audio through a speaker of the portable device; wherein steps (a) through (h) are performed entirely on the portable device without transmitting any user data to an external network.

14. The method of claim 13, further comprising, prior to step (e), validating a digital signature of the Domain Pack archive using a post-quantum digital-signature algorithm, and refusing to access the Domain Pack archive if validation fails.

15. The method of claim 13, further comprising receiving sensor data from a removable multimodal sensor module, generating vision embeddings from the sensor data, and fusing the vision embeddings with text embeddings derived from the text in step (f) to generate the response.

16. The method of claim 13, further comprising, when the Domain Pack archive contains adapter weight files, applying the adapter weight files to modify parameters of the quantized language model to specialize inference for a domain associated with the Domain Pack archive without replacing the base language model.

17. The method of claim 13, wherein retrieving relevant passages in step (e) comprises streaming data pages of the Domain Pack archive directly from non-volatile storage without fully extracting the archive into working memory.

18. A non-transitory computer-readable storage medium configured as a removable Domain Pack for use with a portable voice-assistant device, the storage medium storing a Domain Pack archive comprising: a manifest file containing metadata including a name, a version, and a hash tree data structure with cryptographic hashes for each component file within the archive; a vector index file containing pre-computed embeddings organized as a navigable graph structure for vector similarity search; a content store containing text passages or passage records associated with the pre-computed embeddings, wherein each pre-computed embedding in the vector index corresponds to at least one text passage in the content store; optionally, adapter weight files for specializing a language model of the portable voice-assistant device for a domain associated with the Domain Pack without replacing a base language model; and a digital signature file containing a post-quantum digital signature, generated by a post-quantum digital-signature algorithm, computed over the manifest file, the vector index file, the content store, and any adapter weight files; wherein the Domain Pack archive is formatted as a container configured to be mounted by firmware of the portable voice-assistant device without full extraction and to augment language-model inference with text passages retrieved from the content store via the vector index file.

19. The storage medium of claim 18, wherein the vector index file comprises vectors in one of float16 and int8 precision organized as a Hierarchical Navigable Small World (HNSW) graph.

20. The storage medium of claim 18, wherein the Domain Pack archive contains domain-specific knowledge optimized for at least one of: disaster-response protocols, medical triage procedures, educational content for offline learning, and multi-language translation data for use in crisis zones.
